(19) United States
(12) Patent Application Publication
(10) Pub. No.: US 2005/0204834 A1
(43) Pub. Date: Sep. 22, 2005

(54) Wireless thread controlling device

(76) Inventors: Francisco Speich, Gipf-Oberfrick (CH); Silvan Borer, Frick (CH)

Correspondence Address: OSTROLENK FABER GERB & SOFFEN, 1180 AVENUE OF THE AMERICAS, NEW YORK, NY, 100368403, US

(21) Appl. No.: 10/509,470

(22) PCT Filed: Apr. 15, 2003
(86) PCT No.: PCT/CH03/00252

§ 371 Date: Sep. 28, 2004

(30) Foreign Application Priority Data
May 10, 2002 (CH) 796/02

(51) Int. Cl. F16H 21/16

(52) U.S. Cl. 74/25

(57) ABSTRACT

The invention relates to a wireless thread controlling device for selectively controlling the movement of a thread (2) oscillating transversally in relation to the longitudinal direction thereof, especially a warp thread (2) of a shedding device pertaining to a mechanical weaving loom. The inventive thread controlling device is provided with at least one lifting device (22) which can be driven in an oscillating manner, and at least one driving mechanism (4) for the thread (2). Furthermore, at least one locking device (28) is provided—said locking device comprising a control means (30) which can be actuated by an actuator (34)—in order to selectively engage the driving mechanism (4) with the lifting device (22). In order to increase performance and service life, and to reduce noise emission, the thread controlling device comprises a damper (40) which connects the individual parts (4a,4b) of the two-part driving mechanism.

### TECHNICAL FIELD

The invention relates to a cordless thread control device according to the preamble of claim 1.

### PRIOR ART

A cordless thread control device of the type initially mentioned is known, for example from GB 1 219 012 A. A driver for the thread, said driver being designed as a steel lifter, has, on its end part facing a detaining device, a hook by means of which the steel lifter can be interlocked selectively with the detaining device. The hook has an arcuate configuration, in order to give the end part of the driver elastic properties intended to, bring about a damping of the interlocking of the hook with the detaining device. Due to the arcuate and resilient design of the hook, the latter is unstable in the longitudinal direction of the steel lifter, with the result that a reliable interlocking of the driver with the detaining device is not ensured. This may lead to an inaccurate operation of the thread control device, to a reduction in the rotational speeds and, finally, to weaving errors in the cloth web produced.

### PRESENTATION OF THE INVENTION

The object of the invention is to design a thread control device of the type initially mentioned, in such a way that it does not have said disadvantages.

In the thread control device initially mentioned, the object is achieved, according to the invention, by means of the characterizing features of claim 1.

Since, in the thread control device, the driver is divided between the lifting device and the control means and the driver parts are connected via an elastic damper member and/or the driver is coupled contactlessly to the lifting device via an electro-magnetic field, acting as a damper, of an electromagnetic coupling device, the loads occurring during the interlocking of the driver on the detaining device are damped and, nevertheless, a reliable interlocking of the driver on the detaining device is ensured. The transmission of force in the thread control device is thereby damped, so that, particularly even in the case of high drive cycles, impacts are mitigated and therefore damage to the detaining means is reduced. This leads, in particular to substantially reduced wear and consequently to a longer useful life, along with an increased performance. Further, the generation of noise is reduced, thus resulting in improved working conditions for the operator.

Advantageous refinements of the thread control devices are described in claims 2 to 13.

It is particularly expedient if, according to claim 2, the damper is designed as a stop for the lifting device, since direct force introduction occurs here.

It is advantageous if, according to claim 3, the coupling device has a permanent magnet which is arranged fixedly on the driver and the pole of which is held suspended between two homopolar poles of a magnetic device which are arranged on the lifting device, in such a way that the driver can be driven as long as said driver is not detained in its movement by the control means. The poles of the permanent magnet may be oriented, according to claim 4, in the direction of movement of the driver or, according to claim 5, transversely to the direction of movement of the driver. It is particularly advantageous if, according to claim 6, the magnetic device of the lifting device is of permanent-magnetic design. However, an electrical design according to claim 7 may also be envisaged in spite of a complicated current supply.

A particularly compact type of construction is obtained if, according to claim 8, as seen in the weft direction and/or warp direction of the shedding device, a detaining device has the same division as the heddles guiding the warp thread.

A particularly flat and effective type of construction is obtained if, according to claim 9, the driver is configured as a flat lifter, one end part of which is configured directly as a control means which can be brought into engagement with a detaining member under the influence of an electromagnetic actuator. It is particularly advantageous, in this case, if, according to claim 10, the actuator is designed as an oblique-pole magnet and, according to claim 11, the end part is designed as a leaf spring. The end part of the driver may, according to claim 12, be provided with a locking recess which cooperates with the detaining member. According to claim 13, the driver cooperates with a return spring which is expediently arranged on the end part which faces away from the control means.

### BRIEF DESCRIPTION OF THE DRAWING

Exemplary embodiments of the invention are described in more detail below with reference to the drawings in which:

FIG. 1 shows a diagrammatic illustration of a first thread control device for a shedding device;

FIG. 2 shows a diagrammatic illustration of a second thread control device for a shedding device;

FIG. 3 shows the thread control device of FIG. 2 in the section III-III;

FIG. 4 shows the thread control device of FIG. 2 in the section IV-IV and on a larger scale;

FIG. 5 shows the thread control device of FIG. 2 in the view V-V;

FIG. 6 shows a diagrammatic illustration of a third thread control device for a shedding device;

FIG. 7 shows the coupling device between the lifting device and the driver according to FIG. 6, but on a larger scale.

### WAYS OF IMPLEMENTING THE INVENTION

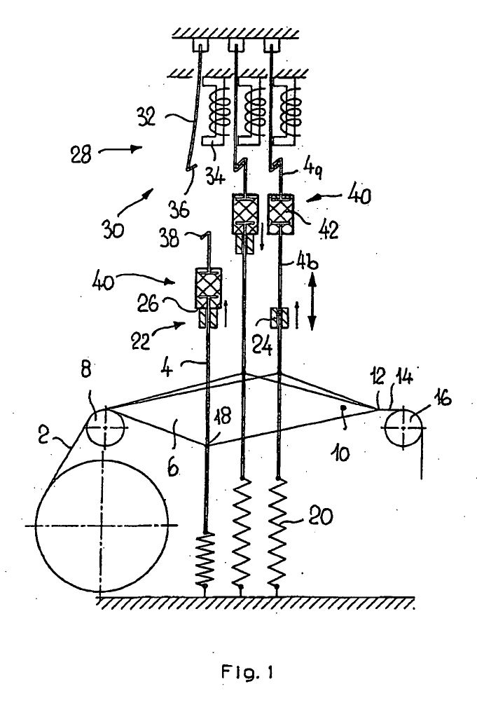

FIG. 1 shows a diagrammatic illustration of a thread control device, such as is suitable particularly as a shedding device for a weaving machine. In the thread control device, the warp threads 2 supplied via a warp beam 8 are opened into a shed 6 by means of drivers 4 designed as heddles. After each shed change, a weft thread 10 is shot into the shed 6 and is beaten up at the cloth edge 12, so that a fabric web 14 is obtained, which is taken up via a cloth beam 16.

The thread control device contains the drivers 4 which have loops 18 through which the warp threads 2 are guided. The drivers 4 are prestressed in one direction, here, for example, downward, into the basic position by means of springs 20. An oscillating lifting device 22 with lift knives 24 engages via a stop 26 on the driver 4 and moves the latter up and down at the rhythm of the lifting device 22, specifically until the driver is blocked in the high position by means of the detaining device 28. The detaining device contains control means in the form a leaf spring 32 which is firmly clamped on one side and which can be pivoted out towards the driver 4 under the influence of an electromagnetic actuator 34, so that a hook 36 of the leaf spring 32 cooperates with a hook 38 of the driver and retains the latter in the upper position, the high shed position.

To damp the driver 4, the latter is divided, and the driver parts 4a, 4b are connected contactlessly by means of a damper 40 which is formed from an elastic member 42 engaging on the lifting knife 24 of the lifting device 22. The impacts of the lifting device which act on the stop 26 are thereby damped, with the result that a generation of noise, on the one hand, and a wear of the thread control device, on the other hand, are reduced in spite of a high drive power. In particular, as a result, the wear of the hooks 36, 38 of the control means 30 and of the driver 4 is appreciably reduced and consequently the service lives 25.of the shedding device are improved.

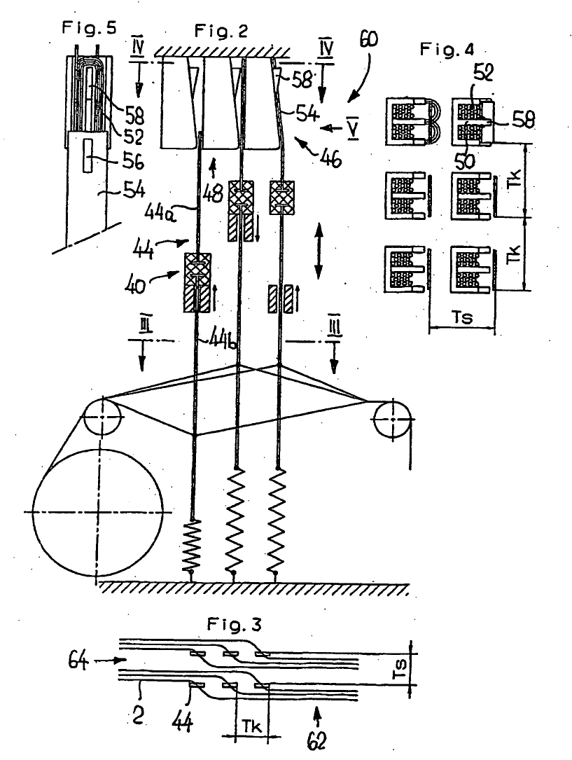

FIGS. 2 to 5 show a further thread control device which is designed in a similar way to the thread control device of FIG. 1 and can be used for shedding on a weaving machine. In this thread control device, the drivers 44 are designed as flat lifters and consist of two driver parts 44a, 44b which are connected contactlessly by means of the damping member 40. The upper end part of the drivers 44 serves as control means 46 and, for this purpose, is configured as a leaf spring which pivots out toward an actuator 48 when the latter is activated. The actuator 48 is configured as an oblique-pole magnet, as is evident particularly from FIG. 2. It has an essentially E-shaped cross section, the middle web 50 of which is provided with a winding 52, so that, when a current is applied, the actuator becomes electromagnetic and attracts the upper end part 54. The upper end part 54, serving as control means 46, of the driver 44 contains an orifice 56, by means of which, with the actuator 48 activated, said driver cooperates with a detaining nose 58 and is retained. As a result, the warp threads moved by the driver 44 can remain in the high shed position until the actuator 48 is deactivated again. The design of the thread control device is such that, as seen in the weft direction 62 and/or warp direction 64 of the shedding device, the detaining devices 60 formed from the actuators 48 and from, the control means 46 have in each case the same division TK and/or TS as the drivers 44 guiding the warp threads 2. This results in a highly compact form of construction of the thread control device which is particularly suitable for the shedding device of a weaving machine.

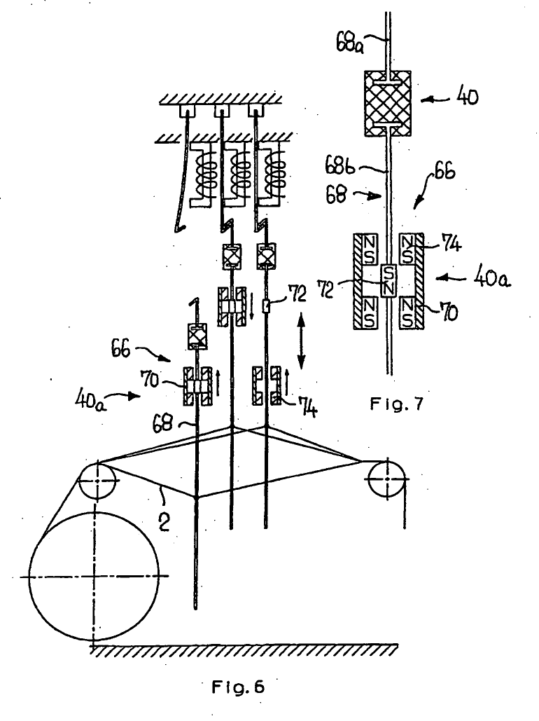

FIGS. 6 and 7 show a further thread control device which is designed in a similar way to FIG. 1 and which has as damper 40a a contactless magnetic coupling device 66, by means of which the drivers 68 are connected to the lifting device 70. The drivers 68 may be of undivided design or additionally of divided design similar to the exemplary embodiment of FIG. 1, in which case the driver parts 68a, 68b are connected contactlessly to one another via a damper 40. The coupling device 66 contains a permanent-magnetic coupling member 72 which cooperates with corresponding coupling members 74 of the lifting device 70, as shown in detail in FIG. 7. The permanent-magnetic coupling member 72 of the driver 68 is oriented in the direction of movement of the driver 68 and cooperates with coupling members 74 of the lifting device 70, which are likewise oriented in the direction of movement, but in the case of which the poles are oriented such that like poles cooperate on each side between the coupling members 72 and 74. As a result of the magnetic field thus formed, the coupling member 72 of the driver 68 is held contactlessly in suspension and driven between the coupling members 74 of the lifting device 70. The coupling device provides a particularly impact-free drive of the drivers, thus having a mitigating effect on noise and wear.

The drivers must have sufficient bending resistance in the direction of displacement and may consist of the most diverse possible materials, such as, for example, plastic, but are conventionally manufactured from steel.

### LIST OF REFERENCE SYMBOLS

2 Warp thread
4 Driver
4a Driver
4b Driver
6 Shed
8 Warp beam
10 Weft thread
12 Cloth edge
14 Fabric web
16 Cloth beam
18 Loop
20 Spring
22 Lifting device
24 Lifting knife
26 Stop
28 Detaining device
30 Control means
32 Leaf spring
34 Actuator
36 Hook of 32
38 Hook of 4
40 Damper
42 Damper
42 Elastic member
44 Driver
44a Upper driver part
44b lower driver part
46 Control means
48 Actuator
50 Web
52 Winding
54 Upper end part 44a
56 Orifice
58 Detaining nose
60 Detaining device
62 Weft direction
64 Warp direction
66 Coupling device
68 Driver
68a Driver
68b Driver
70 Lifting device
72 Coupling member for 68
74 Coupling member for 70

1-13. (canceled)

14. A cordless thread control device for selective control of an oscillating
movement of a thread transversely to its running direction, comprising:
at least one lifting device capable of being driven in oscillation;
at least one driver having a guide for the thread; and
at least one detaining device having control means actuable by an actuator to bring the driver selectively into engagement with the lifting device, the driver having a damper, the driver being bend-resistant in a longitudinal direction and being divided between the lifting device and the control means, the driver having parts connected to one another by an elastic damper member and/or the driver being capable of being coupled contactlessly to the lifting device via an electromagnetic field, acting as a damper, of an electromagnetic coupling device.

15. The thread control device as defined in claim 14, wherein the damper is configured as a stop for the lifting device.

16. The thread control device as defined in claim 14, wherein the coupling device includes a permanent magnet arranged fixedly on the driver, the magnet having a pole held suspended between two homopolar poles of a magnetic device which are arranged on the lifting device so that the driver is driven as long as said driver is not detained by the control means.

17. The thread control device as defined in claim 16, wherein the poles of the permanent magnet are oriented in a direction of movement of the driver.

18. The thread control device as defined in claim 16, wherein the poles of the permanent magnet are oriented transversely to a direction of movement of the driver.

19. The thread control device as defined in claim 16, wherein the magnetic device of the lifting device is of permanent-magnetic design.

20. The thread control device as defined in claim 16, wherein the magnetic device of the lifting device is of electromagnetic design.

21. The thread control device as defined in claim 14, wherein the thread is a warp thread of a shedding device of a weaving machine.

22. The thread control device as defined in claim 21, wherein the detaining device, as seen in weft direction and/or warp direction of the shedding device, has an equal division as the drivers guiding the warp threads.

23. The thread control device as defined in claim 14, wherein the driver is configured as a flat lifter having one end part formed as a control means which is bringable into engagement with a detaining member under influence of an electromagnetic actuator.

24. The thread control device as defined in claim 23, wherein the actuator is an oblique-pole magnet.

25. The thread control device as defined in claim 23, wherein the end part of the driver is a leaf spring.

26. The thread control device as defined in claim 23, wherein the end part of the driver has a locking recess that cooperates with the detaining member.

27. The thread control device as defined in claim 14, wherein the driver cooperates with a return spring arranged on an end part facing away from the control means.
